(19) United States
(12) Patent Application Publication
(10) Pub. No.: US 2010/0031328 A1
(43) Pub. Date: Feb. 4, 2010

(54) SITE-SPECIFIC CREDENTIAL GENERATION USING INFORMATION CARDS

(75) Inventor: Andrew A. Hodgkinson, Pleasant Grove, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/184,155

(22) Filed: Jul. 31, 2008

(51) Int. Cl. G06F 15/16

(52) U.S. Cl. 726/5

(57) ABSTRACT

Systems and methods for generation of site-specific credentials using information cards are provided. An apparatus can include a machine, a browser on the machine configured to receive a request from a relying party site for a credential from a user, a receiver to receive one or more inputs, a site-specific credential generator to generate the credential based on the inputs, and a transmitter configured to transmit the generated credential to the relying party site.

### RELATED APPLICATION DATA

This application is related to co-pending and commonly owned U.S. application Ser. Nos. 11/843,572, 11/843,638, 11/843,640, 11/843,608, and 11/843,591, all of which were filed on Aug. 22, 2007, and claim the benefit of U.S. Application Ser. Nos. 60/895,312, 60/895,316, and 60/895,325, all of which were filed on Mar. 16, 2007; and is related to co-pending and commonly owned U.S. application Ser. No. 12/019,104, filed on Jan. 24, 2008, which claims the benefit of U.S. Application Ser. No. 60/973,679, filed on Sep. 19, 2007; and is related to co-pending and commonly owned U.S. application Ser. No. 12/038,674, filed on Feb. 27, 2008; and is related to co-pending and commonly owned U.S. application Ser. No. 12/044,816, filed on Mar. 7, 2008; and is related to co-pending and commonly owned U.S. application Ser. No. 12/170,384. All of the foregoing applications are hereby incorporated by reference herein.

### TECHNICAL FIELD

The disclosed technology pertains to performing on-line transactions using information cards, and more particularly to generating site-specific credentials based at least in part on information cards.

### BACKGROUND

When a user interacts with sites on the Internet (hereafter referred to as “service providers” or “relying parties”), the service provider often expects to know something about the user that is requesting the services of the provider. The typical approach for a service provider is to require the user to log into or authenticate to the service provider's computer system. But this approach, while satisfactory for the service provider, is less than ideal for the user. First, the user must remember a username and password for each service provider who expects such information. Given that different computer systems impose different requirements, and the possibility that another user might have chosen the same username, the user might be unable to use the same username/password combination on each such computer system. (There is also the related problem that if the user uses the same username/password combination on multiple computer systems, someone who hacks one such computer system would be able to access other such computer systems.) It is estimated that an average user has over 100 accounts on the Internet. For users, this is becoming an increasingly frustrating problem to deal with. Passwords and account names are too hard to remember. Second, the user has no control over how the service provider uses the information it stores. If the service provider uses the stored information in a way the user does not want, the user has relatively little ability to prevent such abuse, and essentially no recourse after the fact.

In the past few years, the networking industry has developed the concept of information cards to tackle these problems. Information cards are a very familiar metaphor for users and the idea is gaining rapid momentum. Information cards allow users to manage their identity information and control how it is released. This gives users greater convenience in organizing their multiple personae, their preferences, and their relationships with vendors and identity providers. Interactions with on-line vendors are greatly simplified.

There are currently two kinds of information cards: 1) personal cards (or self-issued cards), and 2) managed cards—or cards that are issued by an identity provider. A personal card contains self-asserted identity information—the person issues the card and is the authority for the identity information it contains. The managed card is issued by an identity provider. The identity provider provides the identity information and asserts its validity.

When a user wants to release identity information to a relying party (for example, a web site that the user is interacting with), a tool known as a card selector assists the user in selecting an appropriate information card. When a managed card is selected, the card selector communicates with the identity provider to obtain a security token that contains the needed information. The use of usernames and passwords is ubiquitous, particularly on the Internet. Use of these materials for authentication purposes inherently has a number of problems associated therewith. For example, people tend to select usernames and passwords that are easy to remember, which means that they are also easy for hackers to guess. Also, people tend to re-use the same set of credentials across multiple sites, thereby leaving multiple accounts vulnerable to attack if the single set of credentials becomes compromised. In addition, credential phishing continues to become even more prevalent. As information card systems (e.g., CardSpace) become more widely supported by relying parties, the use of usernames and passwords will diminish. Until that happens, however, there will continue to be a great need for a way to address these and other problems associated with the prior art.

### SUMMARY

Embodiments of the disclosed technology can desirably allow information cards to be used for authentication purposes for sites that require usernames and passwords. In an exemplary deployment, a user could use a single self-issued information card to authenticate to an information card enabled site and also to a traditional username/password-based site.

The disclosed technology provides various advantages over the prior art. For example, generated credentials are desirably significantly harder for hackers to guess because policies for generating credentials can specify a requirement for a strong mix of letters, numbers, and symbols. Also, the dangers associated with phishing attacks are greatly reduced because the credentials are generated using both information card and site-specific information (e.g., the corresponding SSL certificate).

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a sequence of communications between a client, a relying party, and an identity provider.

FIG. 2 shows details of the computer system of FIG. 1, such as a card selector, a receiver, a transmitter, and a browser.

FIG. 3 shows an example of an information card that includes a user's name, address, age, and credential (credential type and credential data).

FIG. 4 shows an example sequence of communications between a computer system and a relying party using a site-specific credential generator in accordance with the disclosed technology.

FIG. 5 shows details of the site-specific credential generator implemented in the embodiment illustrated in FIG. 4.

FIG. 6 shows a flowchart of an exemplary procedure to generate a site-specific credential in accordance with the disclosed technology.

### DETAILED DESCRIPTION

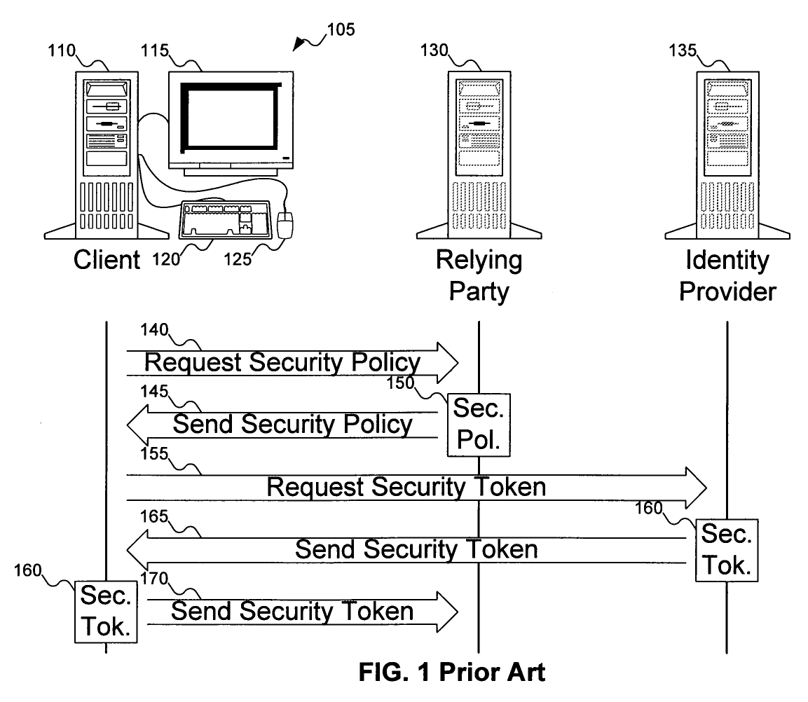

Before describing various embodiments of the disclosed technology, it is important to understand the context of the disclosed technology. FIG. 1 shows an example of a sequence of communications between a client, a relying party, and an identity provider. For simplicity, each of the parties (the client, the relying party, and the identity provider) may be referred to by their respective machines. Actions attributed to each party are taken by that particular party's machine, except where the context indicates that the actions are taken by the actual party itself.

In FIG. 1, a computer system 105 (the client) is shown as including a computer 110, a monitor 115, a keyboard 120, and a mouse 125. A person skilled in the art will recognize that other components can be included with the computer system 105, such as other input/output devices (e.g., a printer), for example. In addition, FIG. 1 does not show some of the conventional internal components of the computer system 105, such as a central processing unit, memory, storage, etc. Although not shown in FIG. 1, a person skilled in the art will recognize that the computer system 105 can interact with other computer systems, such as a relying party 130 and an identity provider 135, either directly or over a network (not shown) of any type. Finally, although FIG. 1 shows the computer system 105 as a conventional desktop computer, a person skilled in the art will recognize that the computer system 105 can be any type of machine or computing device capable of providing the services attributed herein to the computer system 105, including, for example, a laptop computer, a personal digital assistant (PDA), or a cellular telephone.

The relying party 130 is typically a machine managed by a party that relies in some way on the identity of the user of the computer system 105. The operator of the relying party 130 can generally be any type of relying party. For example, the operator of the relying party 130 can be a merchant running a business on a website. Alternatively, the operator of the relying party 130 can be an entity that offers assistance on some matter to registered parties. The relying party 130 is so named because it relies on establishing some identifying information about the user.

The identity provider 135, on the other hand, is typically managed by a party responsible for providing identity information (or other such information) about the user for consumption by the relying party 130. Depending on the type of information the identity provider 135 stores for a user, a single user might store identifying information with a number of different identity providers 135, any of which might be able to satisfy the request of the relying party 130. For example, the identity provider 135 might be a governmental agency responsible for storing information generated by the government, such as a driver's license number or a social security number. Alternatively, the identity provider 135 might be a third party that is in the business of managing identity information on behalf of a wide variety of users.

Conventional methodology of releasing identity information can be found in a number of sources, such as a document published by Microsoft entitled “Introducing Windows CardSpace,” which can be found on the World Wide Web at http://msdn2.microsoft.com/en-us/library/aa480189.aspx and is hereby incorporated by reference. To summarize the operation of Windows CardSpace, when a user wants to access some data from the relying party 130, the computer system 105 requests the security policy of the relying party 130, as shown in a communication 140, which is returned in a communication 145 as a security policy 150. The security policy 150 is typically a summary of the information the relying party 130 needs, how the information should be formatted, and so on.

Once the computer system 105 has the security policy 150, the computer system 105 can identify which information cards will satisfy the security policy 150. Different security policies might result in different information cards being usable. For example, if the relying party 130 simply needs a username and password combination, the information cards that will satisfy this security policy will typically be different from the information cards that satisfy a security policy requesting the user's full name, mailing address, and social security number. The user can then select an information card that satisfies the security policy 150.

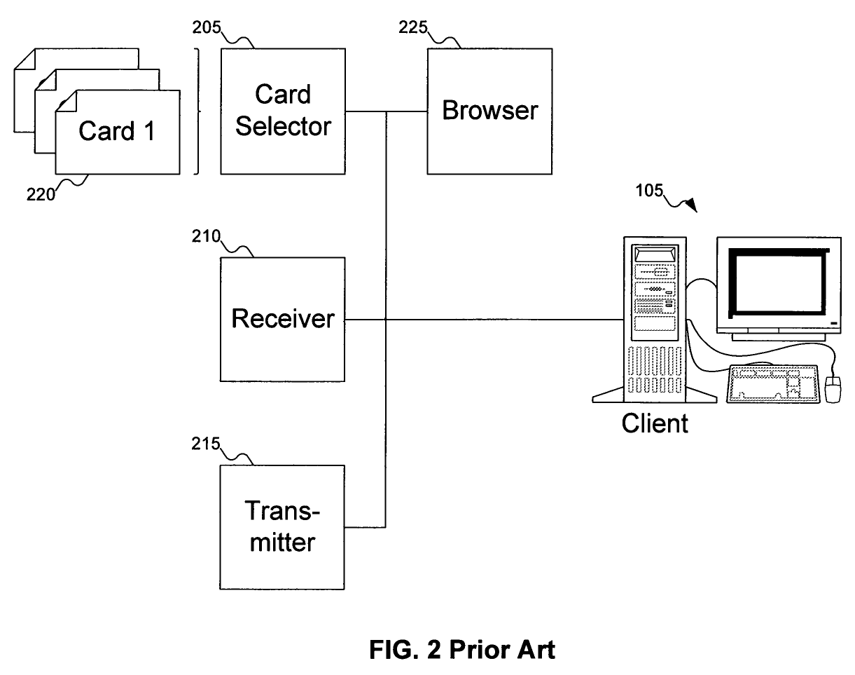

A card selector (described below with respect to FIG. 2) on the computer system 105 may be used by the user to select the appropriate information card. The card selector may present the user with a list or graphical display of all available information cards, and information cards that satisfy the security policy may be highlighted in some way to distinguish them from the remaining cards. Alternatively, the card selector may display only the information cards that will satisfy the security policy. The card selector may provide a means for the user to select the desired information card by, for instance, a mouse click or a touch on a touch screen.

Once the user has selected an acceptable information card, the computer system 105 can use the selected information card to transmit a request for a security token from the identity provider 135, as shown in a communication 155. This request can identify the data to be included in the security token, the credential that identifies the user, and other data the identity provider needs to generate the security token. The identity provider 135 can return a security token 160, as shown in a communication 165. The security token 160 can include a number of claims (e.g., pieces of information) that typically include data that the user wants to release to the relying party. The security token 160 is usually encrypted in some manner, and perhaps signed and/or time-stamped by the identity provider 135 so that the relying party 130 can be certain that the security token originated with the identity provider 135, as opposed to being spoofed by someone intent on defrauding the relying party 130. The computer system 105 can then forward the security token 160 to the relying party 130, as shown in a communication 170.

In addition, the selected information card can be a self-issued information card (also called a personal card): that is, an information card issued not by an identity provider, but by the computer system 105 itself. In that case, the identity provider 135 effectively becomes part of the computer system 105.

In this model, a person skilled in the art will recognize that because all information flows through the computer system 105, the user has a measure of control over the release of the user's identity information. The relying party 130 only receives the information the user wants the relying party 130 to have, and does not store that information on behalf of the user (although it would be possible for relying party 130 to store the information in the security token 160: there is no effective way to prevent such an act).

It should be apparent to a person skilled in the art that in order for this system to work, the user must have one or more information cards available for use, when required by a relying party. In the case of personal cards, the user can simply create the cards as desired. But in the case of managed cards, the user must interact with an identity provider to obtain each managed card.

FIG. 2 shows details of the computer system of FIG. 1. Referring to FIG. 2, the computer system 105 includes a card selector 205, a receiver 210, a transmitter 215, and a browser 225. The card selector 205 is typically responsible for enabling a user to select an information card 220 that satisfies the security policy (e.g., as described above with respect to FIG. 1). The card selector 205 is also typically responsible for enabling a user to obtain managed cards from identity providers and to install the managed cards on the computer system 105. The receiver 210 is generally responsible for receiving data transmitted to the computer system 105, while the transmitter 215 is usually responsible for transmitting information from the computer system 105. The receiver 210 and the transmitter 215 may facilitate communications between, for example, the computer system 105, the relying party 130, and the identity provider 135. The browser 225 can allow the user to interact with web pages on a network, such as web pages created by the identity provider 135. The user may use the browser 225 to obtain a managed card by, for example, visiting a web page created by the identity provider 135 and filling out a web-based form.

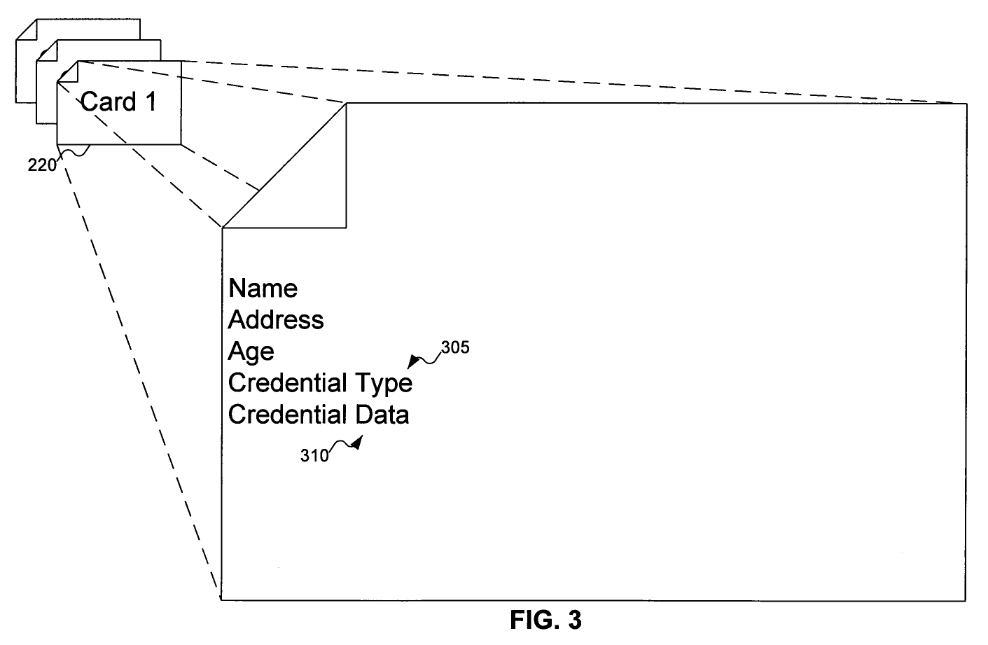

An example of an information card having a credential is illustrated in FIG. 3, which shows the information card 220 of FIG. 2 in greater detail. The information card 220 includes the user's name, address, age, and credential. In particular, the information card 220 includes a credential type 305 and credential data 310. The credential type 305 can be any credential type associated with information cards including, but not limited to, username/password, X.509 certificate, and/or personal card. The credential data 310 includes information that is specific to the credential type 305 of the information card 220. For example, if the credential type 305 of the information card 220 is username/password, the credential data 310 can include a username and a password. If the credential type 305 of the information card 220 is personal card, then the credential data 310 can include a private personal identifier (PPID) of the personal card calculated with respect to the identity provider 135. A person skilled in the art will recognize that the credential type 305 can include other types of credentials and that the credential data 310 will include information that is specific to these other types of credentials. Although the information card 220 is shown as including the user's name, address, age, and credential, information cards can include many other types of information, such as driver's license number, social security number, etc.

Where the information card 220 is a managed information card (that is, managed by an identity provider 135), the information represented by the information card 220 is not actually stored on the user's computer. This information is stored by the identity provider 135. Thus, the information displayed on the information card 220 would not be the actual information stored by the computer system 105, but rather an indicator of what information is included in the information card 220.

Information card selectors (e.g., the CardSpace selector and DigitalMe) are typically required to implement a mechanism for generating site-specific identifiers, which means that each information card has an associated set of cryptographically random bytes that can be used in conjunction with site-specific information (e.g., SSL certificates) to generate a unique RSA key pair (e.g., via X9.31) and/or site identifier. These cryptographic materials can be leveraged to generate site-specific usernames and/or passwords. Thus, a user can still enjoy many of the benefits of information card technologies even if a relying party site is not information card enabled. Also, by leveraging the cryptographic materials associated with information cards to generate username/password credentials on demand, there is no longer a need to store usernames and/or passwords on disk.

When a relying party site is information-card enabled, a user typically clicks on a link or button (or performs some other type of input operation) that causes a corresponding information card selector to be invoked. For example, the user can select an available card, review the claim values that will be disclosed, and approve (or disapprove) the release of a token to the relying party.

In contrast, implementations of the disclosed technology desirably interact with sites that typically expect the user to type a username and/or password into a login form. There are many techniques for identifying and processing such forms, any of which may be appropriate for inserting the credentials, once they have been generated, into the login form. In certain embodiments, for example, a user can invoke a card selector via a context-sensitive pop-up menu (e.g., launched by right-clicking the mouse). Invoked in this way, the card selector would then desirably be launched in a special “credential generation” mode, in which the user could select a particular information card. Responsive to the card selection, a username and/or password specific to the site would be generated and passed back to the browser (e.g., an extension or an add-on to the browser). The browser would subsequently perform the form-fill needed to populate the login form with the username and password.

There are many strong credential generation techniques that can be used in implementations of the disclosed technology. Guidelines for generation can be geared toward making passwords less easily discovered by intelligent guessing. For example, generated credentials can include numbers, upper and lowercase letters in passwords, and symbols, be around 12 to 14 characters in length, and not be based on repetition, dictionary words, letter or number sequences, usernames, or biographical information such as names or dates.

Embodiments of the disclosed technology can use a SHA-256 hash function (or other cryptographic hash function) of the site-specific private key as entropy into the credential generation algorithm. In certain implementations, the credential can be generated according to section 7.6.1 of “A Technical Reference for the Information Card Profile V1.0” (hereby incorporated by reference), which describes key generation performed according to the ANSI X9.31 standard for cryptography. The general mechanism can start with requiring the use of six random (pseudo-random) values denoted as Xₚ₁, Xₚ₂, X_{q1}, X_{q2}, Xₚ, and X_{q}, where the Xₚ and X_{q} values are required to be at least 512 bits and each independently carries the full entropy of any information card master key of up to 512 bits in length. Such a key-generation mechanism can be used to generate 1,024- or 2,048-bit RSA keys. Since sites have varying policies regarding the count and mix (e.g., alphanumeric or symbol) of characters required in passwords, implementations can allow the card selector a per-site override of the default policy for credential generation.

Certain implementations of the disclosed technology can take many of the various benefits of CardSpace technology (e.g., anti-phishing features) and effectively move them into legacy space so that they can desirably provide comparable benefit to existing websites that are username/password-based (e.g., using cryptographic material in an information card such as master key & hash salt). Thus, a unique password can be generated on a per-site basis and, using a browser add-on, for example, a user can go to the site, right-click over (or otherwise direct focus to) a password field, and have the card selector generate a password that is specific to the particular website/information card combination and automatically fill in the pertinent information. So, for example, if a user is redirected to a fake banking site and follows the same flow, the password specific to the fake site would advantageously be different than the password to the real banking site.

Certain implementations can include filling in both username and password fields (e.g., where both would be generated specific to the website/information card combination). For a username, a corresponding username value can be fed into a site-specific credential generation algorithm (as opposed to current systems, which typically generate a relying party ID based on a master key, hash salt, and relying party certificate).

In certain implementations of the disclosed technology, the site-specific credential generator can receive the following inputs: a relying party site identifier, information card information, and a flag/setting. The relying party site identifier can be a certificate corresponding to the site. The information card information, particularly cryptographic information within the information card, is generally constant or relatively static information. The flag/setting can include an identifier to be used in generating the desired username/password variant.

In certain embodiments of the disclosed technology, the output of the site-specific credential generator is similar to a private personal identifier (PPID). The output can be desirably used as an account identifier (or part thereof) at the corresponding relying party site. Furthermore, in certain embodiments, a PPID could be one of multiple outputs of the site-specific credential generator.

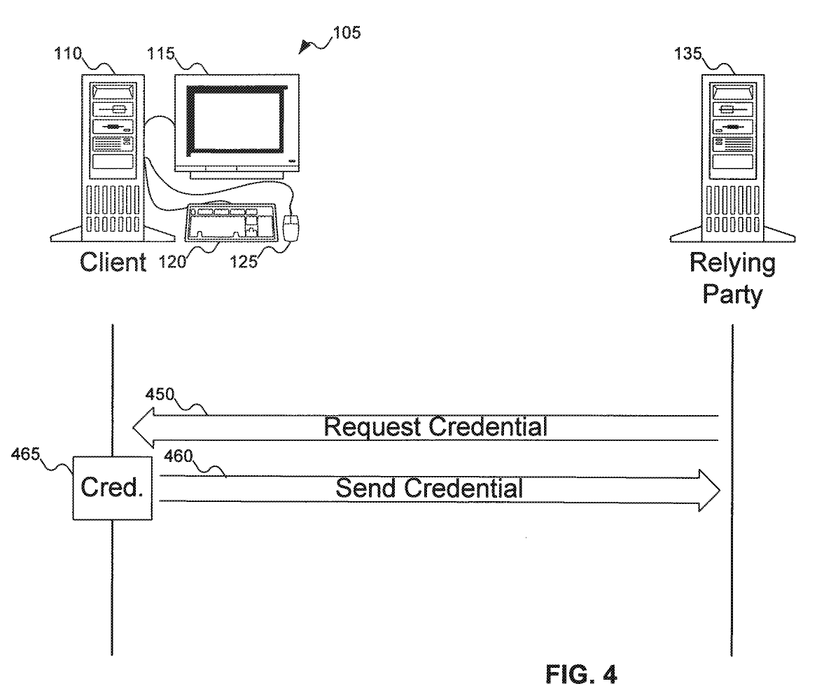

FIG. 4 shows an example sequence of communications between a computer system and a relying party using a site-specific credential generator in accordance with the disclosed technology. When a user wants to enter a particular website using the computer system 105, the relying party 135 sends a request 450 for a credential to the computer system 105. The request 450 can be sent by the browser 225 on the computer system 105 and can be initiated by, for example, a user selecting a button on the website indicating the user's desire to access the site. The request 450 can specify a credential type (e.g., username/password) and, depending on the credential type, credential data.

In the example, the computer system 105 can prompt the user (e.g., via the browser 225) or perform a search for certain information such as a relying party site identifier (e.g., a relying party certificate), information card information (e.g., cryptographic information), and a flag. Information card information can include, for example, which particular information card the user selects. The selected card will typically include identity information specific to the user (e.g., user information). Also, the flag can be a setting that is used to specify a particular variant to be used for the generated username/password. Based on the information inputted to the computer system 105 in response to the prompting/searching, the system can generate a credential 465 (e.g., username and password) that is then sent 460 back to the relying party 135. Thus, a site-specific credential has been advantageously generated and sent to the relying party site.

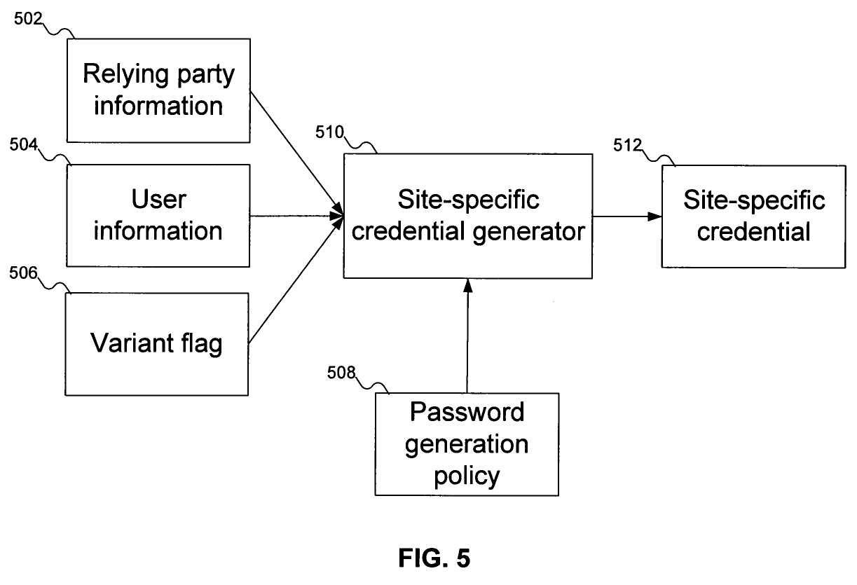

FIG. 5 shows details of the site-specific credential generator embodiment illustrated in FIG. 4. Responsive to a user's actions indicating a desire to access a particular website (e.g., prompting a login form on the site), a site-specific credential generator 510 can request, search, and/or be provided with several inputs such as, but not limited to, relying party information 502 (e.g., a relying party site identifier), user information 504 (e.g., an information card selected by the user), and a flag 506 (e.g., indicating a particular variant to be used). The site-specific credential generator can use an algorithm such as those discussed above (e.g., implementing a SHA-256 hash function) to generate a credential 512 (e.g., username/password) specific to the relying party site.

In alternative embodiments, a password generation policy 508 can also be requested and/or provided to the site-specific credential generator 510 and be used in the generation process. For example, the password generation policy 508 can specify certain parameter requirements to meet a certain level of password strength. Thus, in such embodiments, the generated credential 512 is based at least in part on the relying party information 502, the user information 504, the flag 506, and the password generation policy 508.

In certain embodiments, if a user were to change his or her password for a particular site, the disclosed technology could create a new self-issued card that would have new cryptographic information therein.

In certain embodiments, a user can create a new username/password variant using the same information card. For example, the user could store something in the information card indicating which variant is to be used for a certain site.

The disclosed technology can be desirably implemented in an information card selector. For example, at a CardSpace login, a user could click on an information card icon at a particular site and select an information card in a pop-up list, and the card selector could send a token to the site. Here, the user could mouse-over or otherwise get focus on the username/password dialog or entry box and use a right-click or hotkey command to indicate that the user wants to fill in the field using a generated password. The selector could pop up and, with the information card selected, the password could be inserted into the field that is active when the card selector is invoked.

When a webpage has an embedded information card login form, certain embodiments of the disclosed technology can include a browser add-on that advantageously detects the particular information card login form and performs the desired processing on it. In such implementations, the system can detect when the user interacts with the form (e.g., the user logs in with information card buttons) and thus determine that it should launch the associated card selector in order to get an appropriate value back. At that point, a token can be generated and handed back to browser add-on, which can then insert it into a variable that is accessible to pertinent JavaScript on the page that will take the token value and do a post back to the relying party. In these implementations, the add-on can detect when the user wants to cause the card selector to pop-up in order to fill in a field on a form (e.g., a password field). The appropriate password can desirably be passed back from the card selector to the add-on, which can then insert it into the form field, at which point the user can click the Enter/Login button, etc.

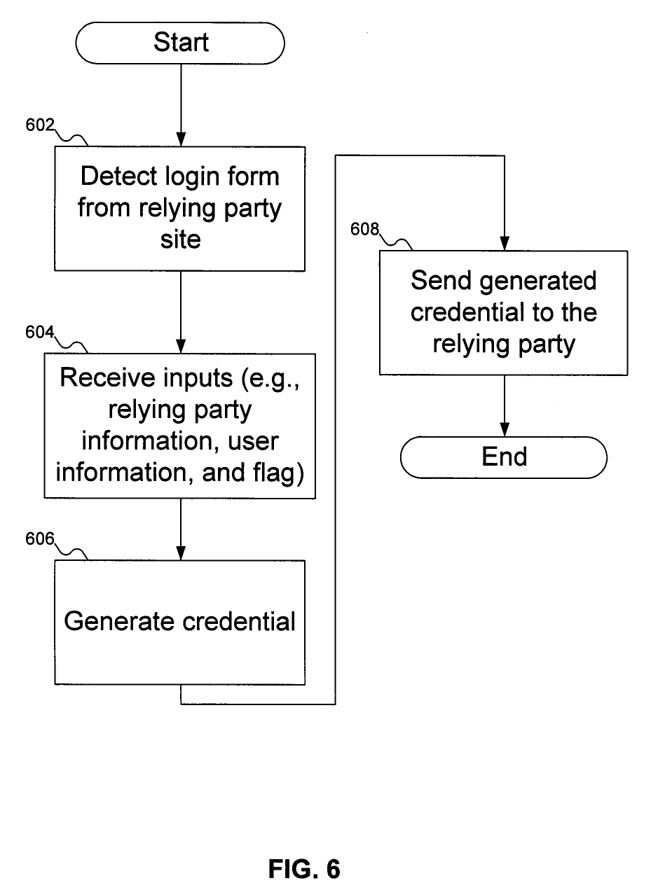

FIG. 6 shows a flowchart of an exemplary procedure to generate a site-specific credential in accordance with the disclosed technology. In the example, the system first detects 602 a login form from the relying party that the user is trying to access. For example, the user may click on an information card button at the site or, alternatively, the system can automatically detect the login form at the relying party site (e.g., based on previous visits by the user to the site). At 604, the site-specific credential generator receives at least the following inputs: relying party information, user information, and a variation flag. In alternative embodiments, the inputs can also include a password generation policy. Based at least in part on the inputs, the site-specific credential generator generates at 606 a credential specific to the relying party site. The generated credential is then sent to the relying party at 608. For example, the system can automatically populate the login form fields with a generated username and a generated password.

In alternative implementations, the pop-up could provide the generated password to the user for a copy/paste action or to allow user to enter the password him/herself. If the user visits the site and the site is recognized as having been previously visited (and generated credentials as having been previously provided), the card selector could desirably be popped up automatically in order to perform form fill and login functions. In such embodiments, the card selector can advantageously pop-up on the site and automatically perform the form-fill processing for the user so that the user does not accidentally type his or her password onto a bogus site, for example.

Generally, strong passwords are based on certain criteria defined in a corresponding policy. For example, if policy specifies that a certain password is not appropriate for the site asking for the password, the user can be desirably presented with a dialog communicating that the password should contain 8-12 characters (e.g., where x characters are numeric and y characters are alphabetical). Thus, a fourth parameter that can be provided as input to a site-specific credential generator in certain embodiments can be a password generation policy. For example, the password generation policy can specify constraints to which the password must adhere in accordance with the policy. If the site has a specific policy, the policy will typically be stored in the metadata of the corresponding information card to be passed into the password generation routine in order to reproduce the password in accordance with the policy.

In certain embodiments, when creating a self-issued card, the system can present the user with a form having, for example, 14 fields fixed by a certain specification for self-issued cards, but not give any information from the relying party. The user can type in the pertinent information, even though it may have no direct relation to the relying party (that is, the only thing specific to the relying party is the generated PPID based on the relying party certificate). The PPID value can thus be incorporated into the pertinent token as a claim value. There can also be a public key in the token identifying the user as the user that previously visited the site.

In certain implementations, the same information card can be desirably used as the basis for credential generation at any number of sites, where each generated password would desirably be different based on the visited site. Also, the same information card can be advantageously used for authentication or form fill purposes at sites that are CardSpace-enabled, for example.

In some embodiments, the pertinent information card can have associated therewith separate metadata (e.g., a password generation policy) for each site as well as a variant identifier for each password at a given site. When each site is visited, the corresponding key pair & PPID can be stored in the information card itself for future use. The site-specific password generation metadata can advantageously be stored therewith.

The various advantageous techniques described herein may be implemented as computer-implemented methods. Additionally, they may be implemented as instructions stored on a tangible computer-readable medium that, when executed, cause a computer to perform the associated methods. Examples of tangible computer-readable media include, but are not limited to, disks (e.g., floppy disks, rigid magnetic disks, and optical disks), drives (e.g., hard disk drives), semiconductor or solid state memory (e.g., RAM and ROM), and various other types of tangible recordable media such as CD-ROM, DVD-ROM, and magnetic tape devices.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. An apparatus, comprising:
a machine;
a browser on the machine configured to receive a request from a relying party site for a credential from a user;
a receiver to receive a plurality of inputs;
a site-specific credential generator to generate the credential based at least in part on the plurality of inputs; and
a transmitter configured to transmit the generated credential to the relying party site.

2. The apparatus of claim 1, wherein the plurality of inputs comprises at least a relying party site identifier, a user identifier, and a variant flag.

3. The apparatus of claim 2, wherein the plurality of inputs further comprises a password generation policy.

4. The apparatus of claim 1, wherein the generated credential comprises a generated username and a generated password.

5. The apparatus of claim 1, wherein the generated credential is automatically populated into a login form at the relying party site.

6. A computer-implemented method of generating a site-specific credential, comprising:
receiving a request from a relying party site for a credential from a user;
receiving a relying party site identifier corresponding to the relying party site;
receiving an information card identifier corresponding to an information card;
receiving a value for a flag; and
generating the credential, wherein the credential is specific to the relying party site based at least in part on the relying party site identifier, the information card identifier, and the value for the flag.

7. The computer-implemented method of claim 6, further comprising receiving a password generation policy.

8. The computer-implemented method of claim 7, wherein the generating comprises generating the credential specific to the relying party site based at least in part on the password generation policy.

9. The computer-implemented method of claim 6, wherein the relying party site identifier comprises a site-specific certificate.

10. The computer-implemented method of claim 6, wherein the information card identifier comprises cryptographic information.

11. The computer-implemented method of claim 6, wherein the information card identifier comprises static information.

12. The computer-implemented method of claim 6, wherein the generated credential comprises a username/password variant.

13. The computer-implemented method of claim 6, wherein receiving the request comprises detecting a login form having multiple login form fields.

14. The computer-implemented method of claim 13, further comprising automatically populating the multiple login form fields with corresponding values from the generated credential.

15. The computer-implemented method of claim 6, further comprising storing the generated credential in the information card.

16. The computer-implemented method of claim 15, further comprising storing in the information card a key pair and private personal identifier (PPID) corresponding to the relying party site.

17. The computer-implemented method of claim 6, wherein generating the credential comprises implementing a SHA-256 hash function.

18. A tangible computer-readable medium storing instructions that, when executed by a processor, result in:
receiving a request from a relying party site for a username and a password;
receiving a plurality of inputs;
based at least in part on the plurality of inputs, generating a username and a password specific to the relying party site; and
transmitting the generated username and password to the relying party site.

19. The tangible computer-readable medium of claim 18, wherein receiving the request comprises automatically detecting a login form at the relying party site, wherein the login form comprises at least a username field and a password field.

20. The tangible computer-readable medium of claim 19, having stored thereon further instructions that, when executed by the machine, result in:
populating the username field with the generated username; and
populating the password field with the generated password.
